(19) United States
(12) Patent Application Publication
(10) Pub. No.: US 2013/0076187 A1
(43) Pub. Date: Mar. 28, 2013

(54) 5-PHASE ALTERNATING CURRENT INDUCTION MOTOR AND INVERTER SYSTEM

(71) Applicant: Adam Daniel Flaster, San Diego, CA (US)

(72) Inventor: Adam Daniel Flaster, San Diego, CA (US)

(21) Appl. No.: 13/621,828

(22) Filed: Sep. 17, 2012

Related U.S. Application Data
(60) Provisional application No. 61/535,907, filed on Sep. 16, 2011.

(51) Int. Cl. H02K 3/28

(52) U.S. Cl. CPC H02K 3/28
USPC 310/159

(57) ABSTRACT

An induction motor having five phases is disclosed. Adding two or more phases to existing 1, 2, and 3 phase designs can boost power, torque, and speed. This document describes a method of controlling a motor and an inverter through load, power, torque, or speed demands. Cooling applications for the system and various electronic filtering methods are also disclosed.

### CROSS REFERENCE TO RELATED APPLICATION

This application claims the benefit under 35 U.S.C. §119(e) of the following provisional application, all of which is incorporated herein by reference in its entirety: U.S. Provisional Patent Application Ser. No. 61/535,907, entitled “5-Phase Alternating Current Induction Motor and Inverter System,” filed on Sep. 16, 2011 (Attorney Docket No. 42036-503P01 US).

### BACKGROUND

The AC Induction Motors exists in 1, 2, and 3 phase designs based on motor applications. These applications can either be for manufacturing equipment, appliances, aerospace, marine, automotive, or other transportations uses based on power, torque, and speed requirements.

However, adding two more phases to the motor can boost power, torque, and speed. This is achieved by boosting the natural frequency of the system by increasing active switching devices. Increasing the number of switches allows for decreased magnetic saturation, increased heat capacity, further power transfer through less materials, and increased power and torque band at higher RPM's.

### SUMMARY

This document presents 5-Phase technology from power supply source conditioning, motor inverter design, motor inverter control, motor design, and motor control method. This document also describes a method of controlling motor and inverter through load, power, torque, or speed demands, as well as cooling applications for the system and electronic filtering for power quality and electromagnetic interference.

### BRIEF DESCRIPTION OF THE DRAWINGS

These and other aspects will now be described in detail with reference to the following drawings.

FIG. 1 illustrates a 5-phase motor.

FIG. 2 illustrates a power electronics configuration.

FIG. 3 illustrates a DC fed 2-phase inverter feeding transformer.

FIG. 4 illustrates a 3-phase AC fed 2-phase inverter feeding transformer.

FIG. 5 illustrates an inverter configuration.

FIG. 6 illustrates inverter configuration A with reverse power feed-in.

FIG. 7 illustrates inverter configuration B with reverse power feed-in.

FIG. 8 illustrates a functional block diagram of a control method for variable frequency drive.

FIG. 9 illustrates a table showing various inverter north/south phase switching configurations and the corresponding phases.

FIG. 10A illustrates U-V′ switching.

FIG. 10B illustrates U-W′ switching.

FIG. 10C illustrates U-X′ switching.

FIG. 10D illustrates U-Y′ switching.

FIG. 10E illustrates V-W′ switching.

FIG. 10F illustrates V-X′ switching.

FIG. 10G illustrates V-Y′ switching.

FIG. 10H illustrates V-U′ switching.

FIG. 10I illustrates W-X′ switching.

FIG. 10J illustrates W-Y′ switching.

FIG. 10K illustrates W-U′ switching.

FIG. 10L illustrates W-V′ switching.

FIG. 10M illustrates X-Y′ switching.

FIG. 10N illustrates X-U′ switching.

FIG. 10O illustrates X-V′ switching.

FIG. 10P illustrates X-W′ switching.

FIG. 10Q illustrates Y-U′ switching.

FIG. 10R illustrates Y-V′ switching.

FIG. 10S illustrates Y-W′ switching.

FIG. 10T illustrates Y-X′ switching.

FIG. 11 illustrates a functional block diagram of a method for field oriented/indirect torque control.

FIG. 12 illustrates a functional block diagram of a method for direct torque control.

FIG. 13 illustrates sinusoidal EMC filtering.

FIG. 14 illustrates “turn-on” and “turn-off” snubbers.

FIG. 15 illustrates the fluid cooling of power electronics.

FIG. 16 illustrates the fluid cooling of a motor.

Like reference symbols in the various drawings indicate like elements.

### DETAILED DESCRIPTION

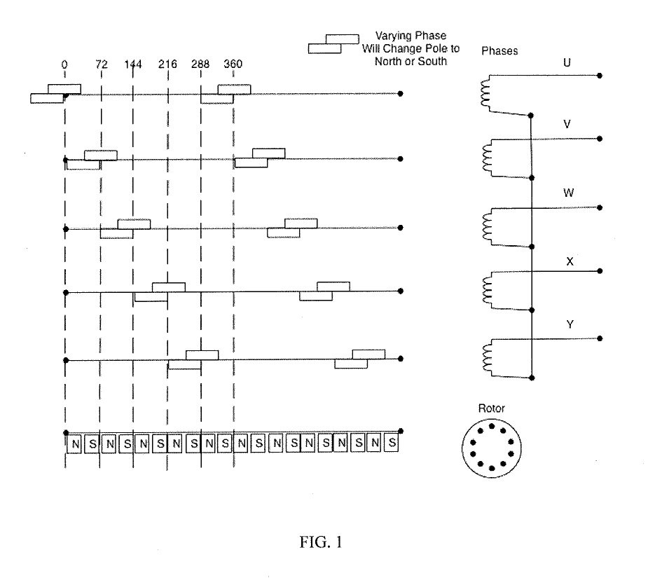

FIG. 1 illustrates a 5-phase Motor. The Motor consists of a stator and rotor controlled by a 5-Phase Inverter. The stator consist of 2, 4, 6, or 8 pole pairs per phase pending torque requirements of application. The rotor can consist of a squirrel cage or solid core design. The Stator phases U, V, W, X, and Y rotate the rotor by switching current direction to induce flux and electromagnetic force onto the rotors.

Phases U, V, W, X, or Y can produce a North or South in one of these phase based on the enabled switching devices in the upper and lower legs of the inverter. Each primary magnetic pole is placed 72 degrees between each other and every 72/M (M=Magnetic pole pairs) for every poling pair pending torque requirements. The rotor rotates by a phase wave creating a push pull motion between poles as they alternate. Speed increases based on voltage and switching frequency, and torque is dependent on current and pole pairs.

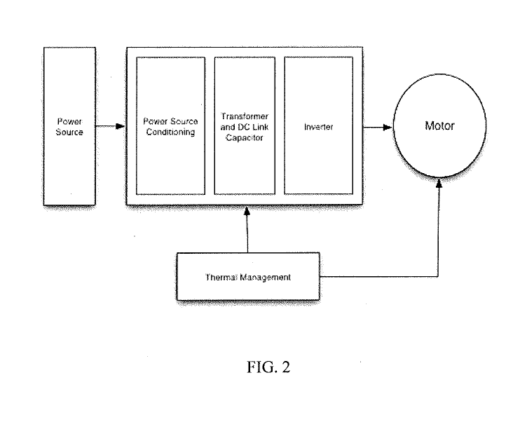

FIG. 2 illustrates a functional block diagram of a power electronics configuration. The configuration consists of a Power Source Input, a DC Link Capacitor, and Forward Inverter with the option of a Reverse Bridge for Regenerative Braking.

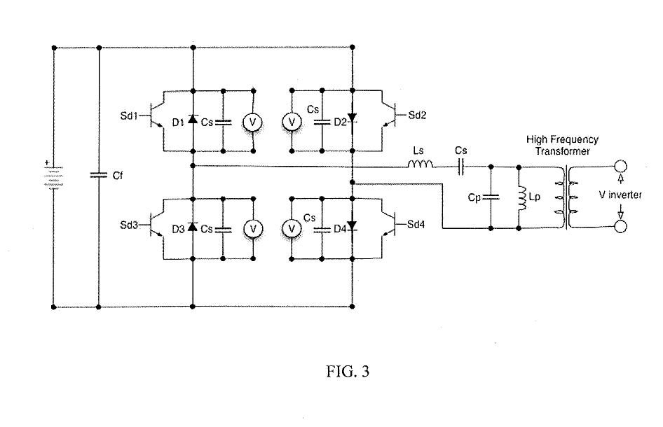

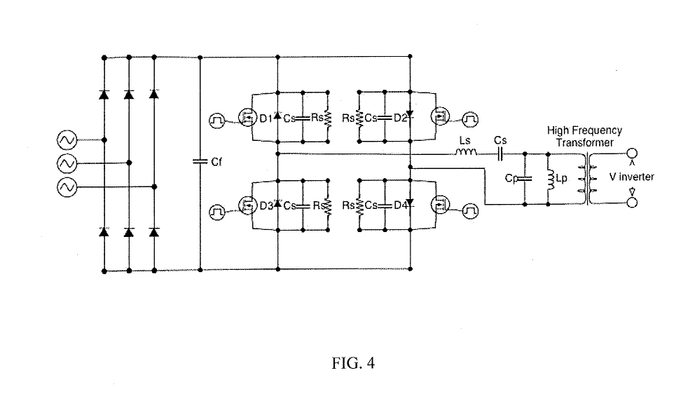

As illustrated in FIG. 3, the Power Source can either be a DC source from a Battery, Capacitor/s, AC/DC Converter, or DC/DC converter. As illustrated in FIG. 4, the Power Source can also be fed by an AC source either 1, 2, or 3-Phased.

The power is then conditioned through a dual phase inverter to the proper Voltage and sinusoidal frequency to a Transformer that can step-up/step-down the voltage and fed into the 5-Phase Inverter. Switching is enabled by a PWM signal and is corrected by feedback through Voltage Monitoring at the Switch Capacitors “Cs” and current at the Transformer.

The power quality is conditioned by a DC-Link Capacitor mounted parallel between the Power Source and Inverter, and rated for peak voltage. Current and Voltage are filtered into the Transformer by a inductor and capacitor (Ls and Cs) in series and also another Capacitor and Inductor in Parallel to the Transformer (Cp and Lp).

FIG. 5 illustrates a configuration for an inverter. Five pairs of upper and lower legs either MOSFET or IGBT switch through a PWM or PDM (depending on control method). The signals to the switch are controlled by an IC (Integrated Circuit), which is varied based on control strategy and power rating. Each switch is mated with a diode to control reverse current. If the system is not equipped with a feed-in/regenerative braking system, a braking resistor controlled by a MOSFET or IGBT is incorporated into the inverter to consume power and protect the DC Link Capacitor.

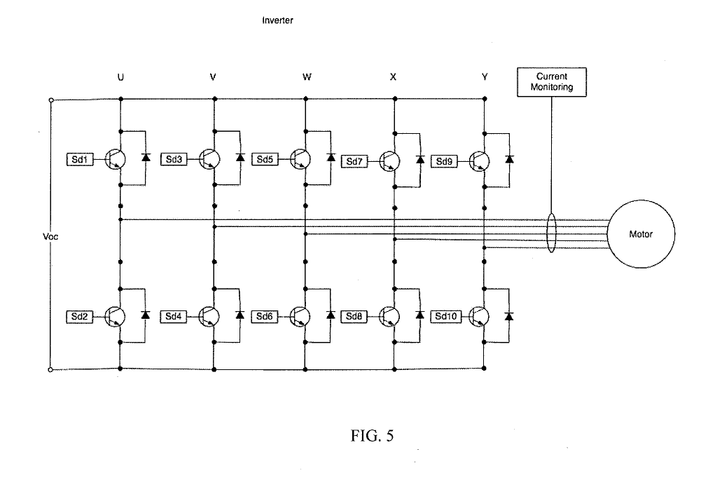

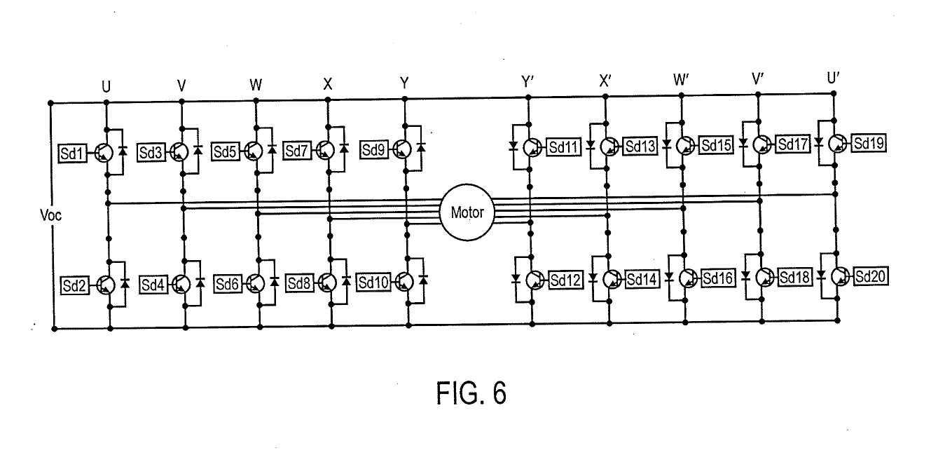

FIG. 6 illustrates another configuration (i.e., configuration A) of the inverter. The inverter in configuration A has a reverse power feed-in. This configuration is just like the Inverter in FIG. 5, with the add in of another set of five upper and lower legs to manage reverse power flow for feed-in/regenerative braking to the power source.

FIG. 7 illustrates another configuration (i.e., configuration B) of the inverter having reverse power feed-in.

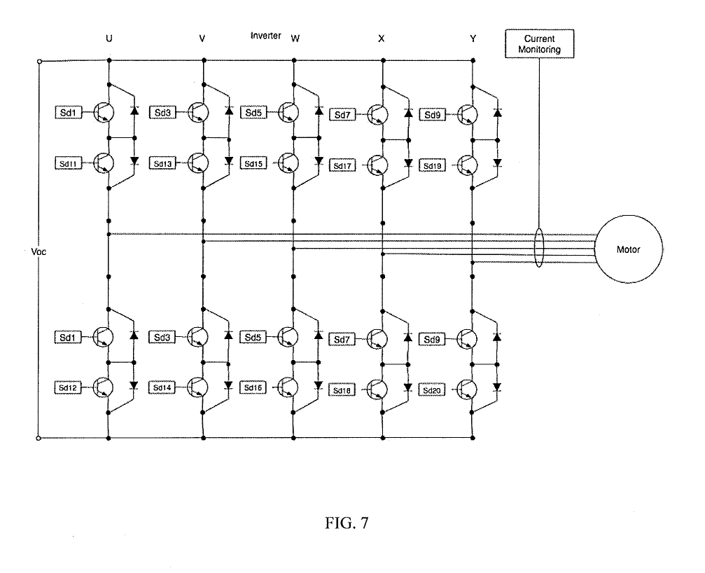

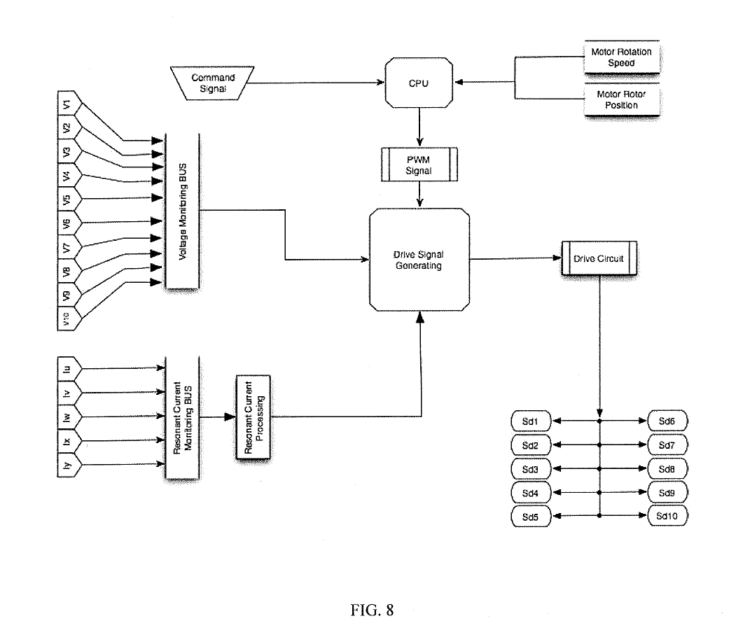

FIG. 8 illustrates a functional block diagram of a control method for variable frequency drive. A Voltage Monitor, Drive Signal Generator, Resonant Processing unit, CPU, and a Drive Circuit that monitor and drive the Inverter based on Power Demand and Motor Speed control the Inverter. The CPU processes the Command Signal from the controller for demand (Torque, Power, Speed, etc) and current motor position and speed and outputs a PWM signal for the 5 Voltage phases into a Drive Signal Generator.

Voltage is measured at the upper and lower legs of the inverter (V1, V2, . . . V10) and fed into a Zero Voltage Detecting Device to monitor voltage levels in the inverter. An algorithm interprets the voltages into switching frequency inputs for the Drive Signal Generator.

The Resonant Current Processor monitors the currents (I1, I2, . . . I5) in the leads into the motor. An algorithm provides a feedback output to the Drive Signal Generator.

The Signal Generator processes the Voltage, PWM, and Resonant Current and outputs based on a set frequency to a drive circuit which outputs to the MOSFET/IGBT switches (Sd1, Sd2, . . . Sd10).

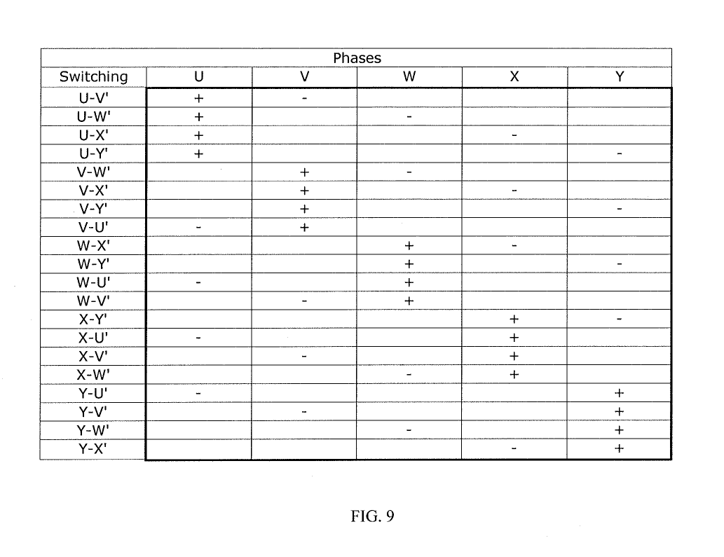

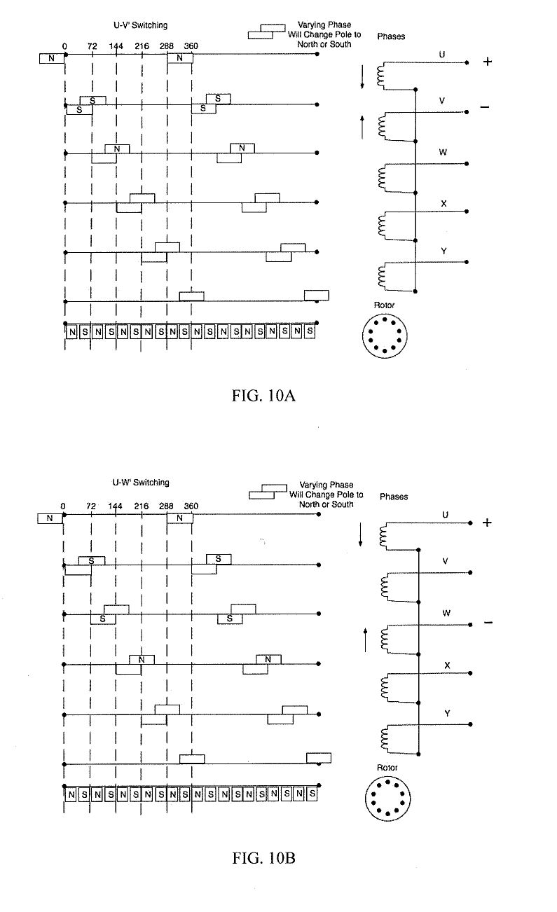

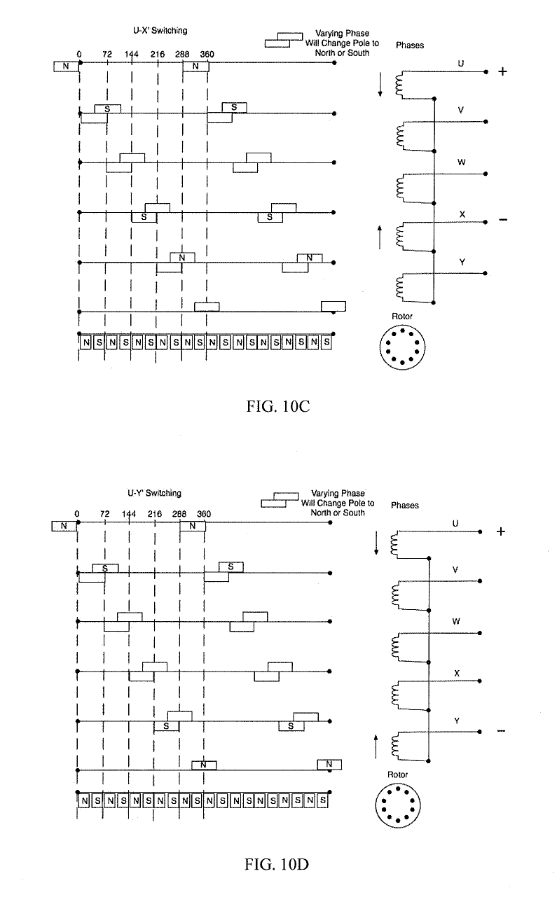

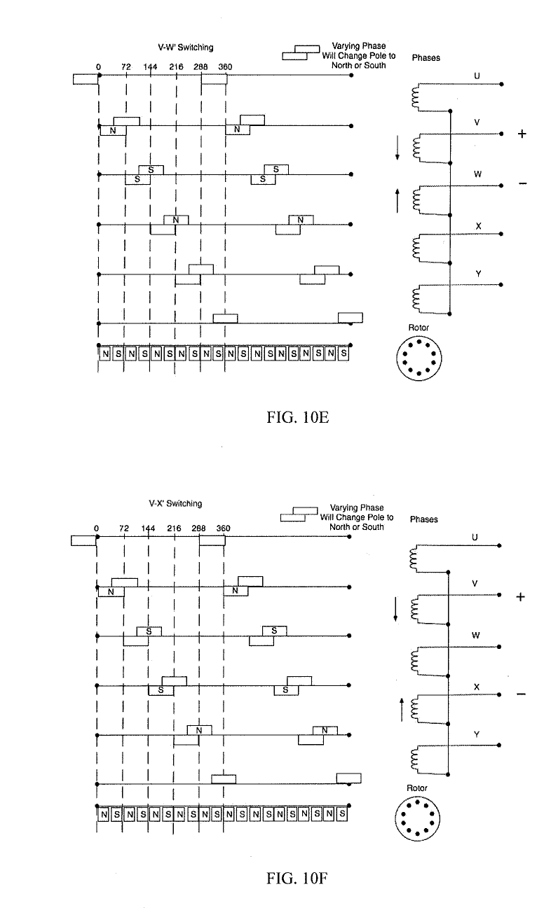

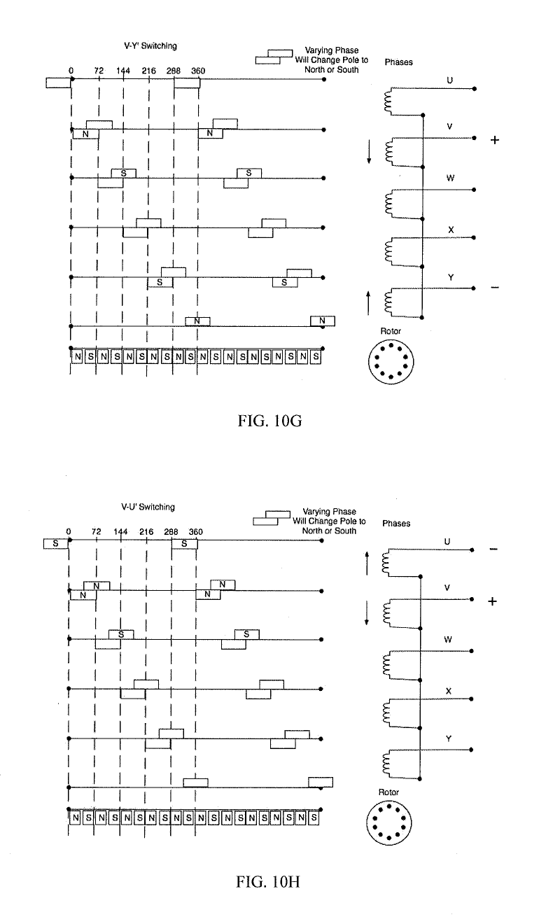

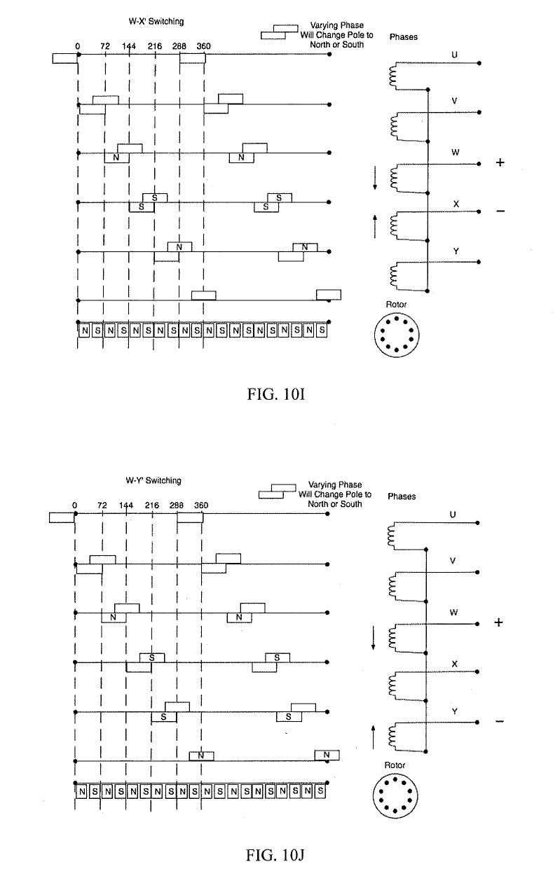

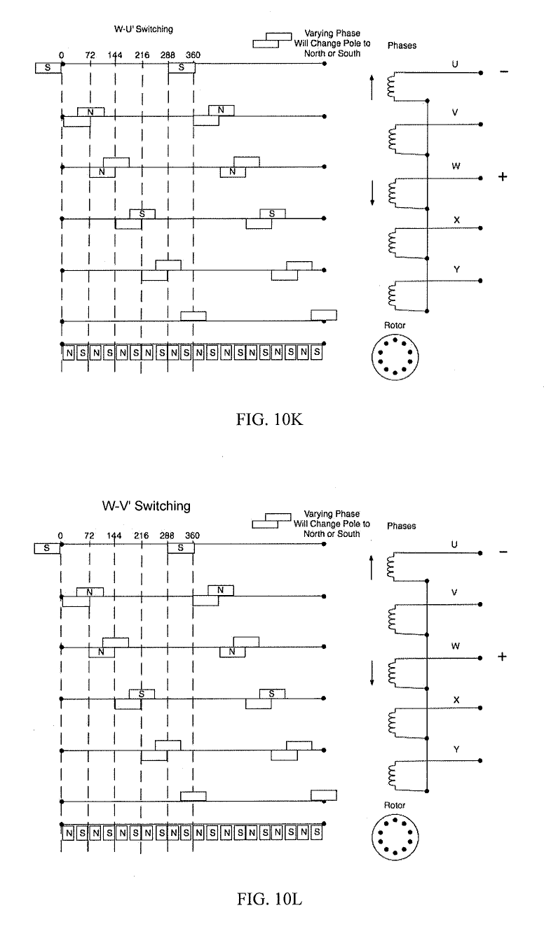

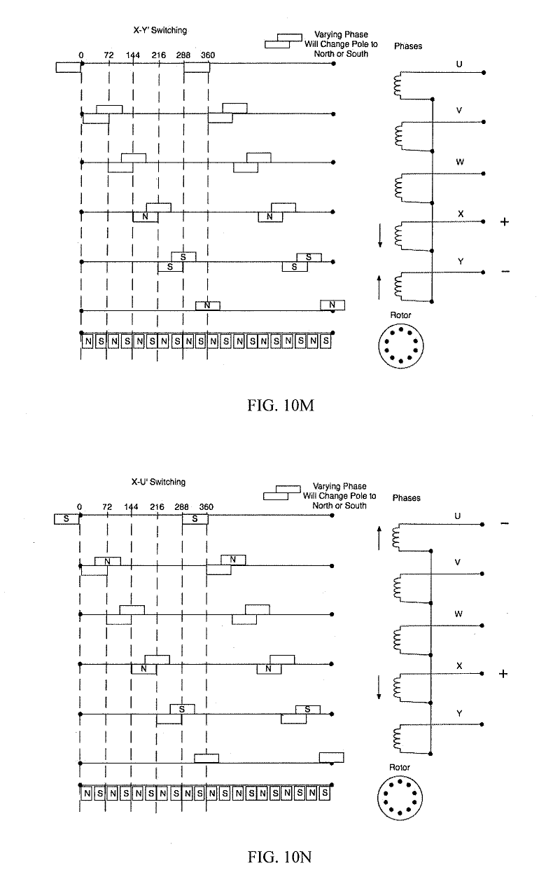

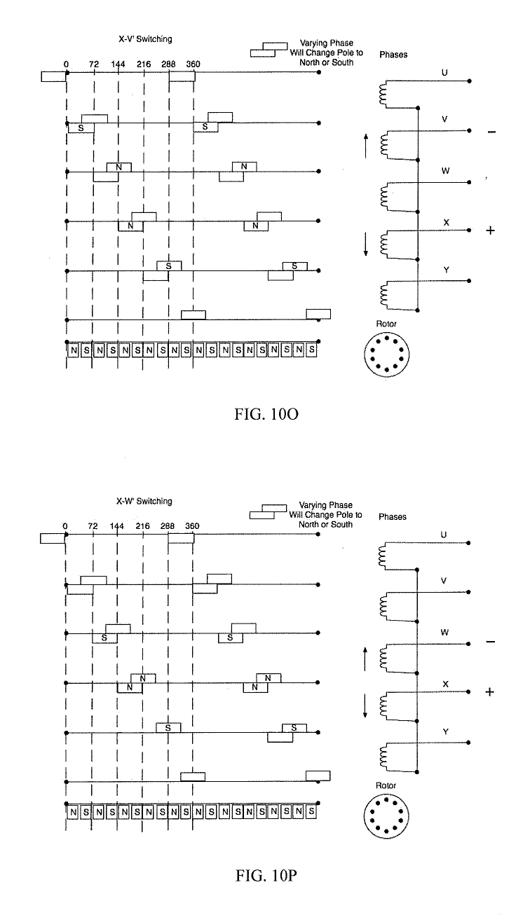

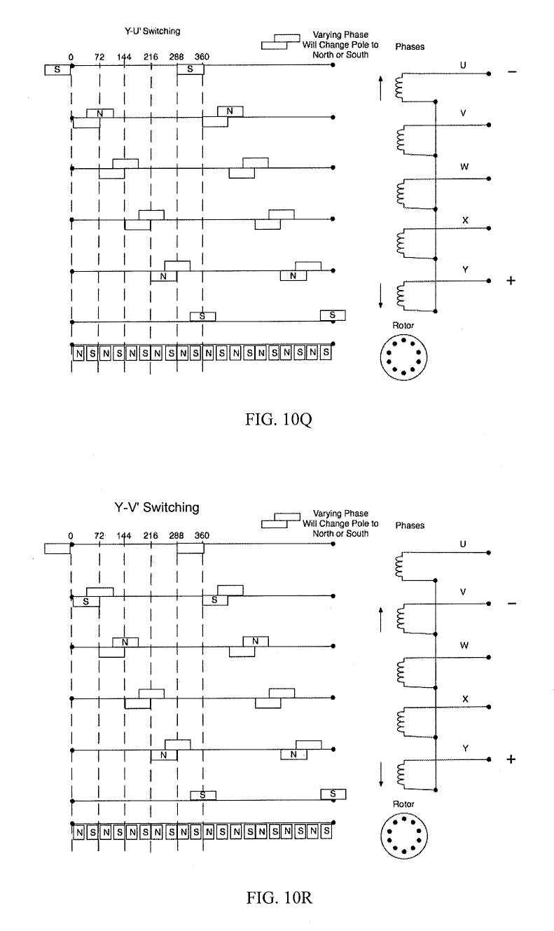

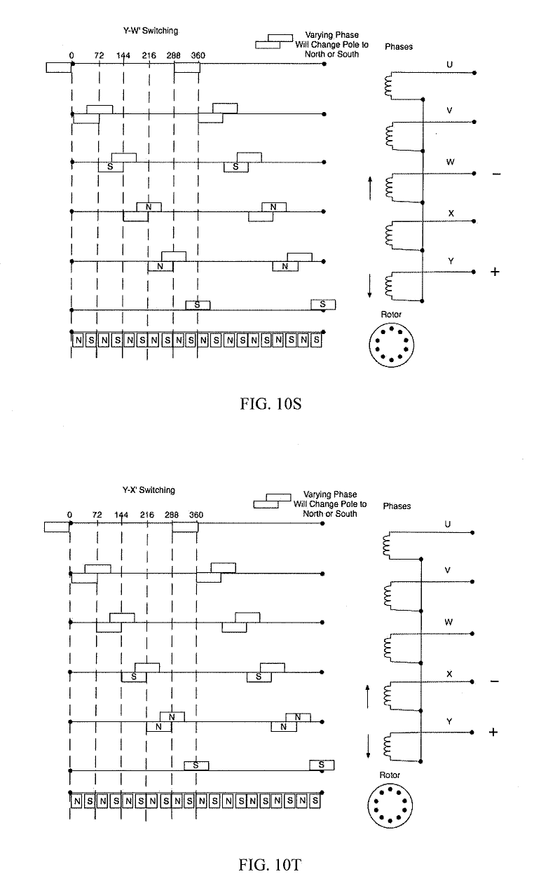

FIG. 9 illustrates a table showing various inverter north/south phase switching configurations and the corresponding phases. FIGS. 10A through 10T illustrate each of the switching configurations identified in FIG. 9.

Variable Frequency Control Drive

Vector Control/ Field-Orient Control (Indirect Torque Control)

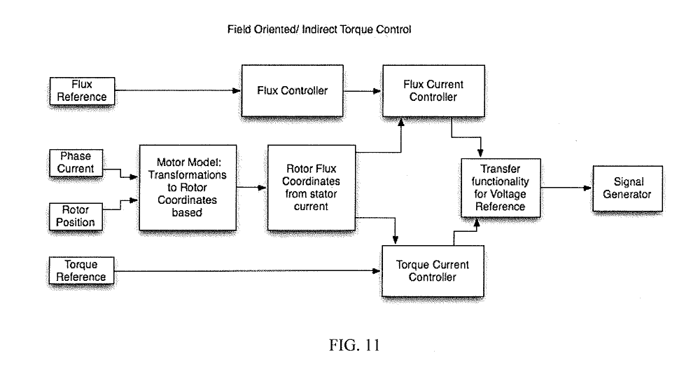

FIG. 11 illustrates a functional block diagram of a method for field oriented/indirect torque control. This method measures Phase currents at the stator and transformed to a coordinate system in the software that is coordinated with the Rotor position. This is then transformed into a rotor flux coordinate and ran through flux and Torque Current controllers based on the Flux and Torque References.

Direct Torque Control (DTC)

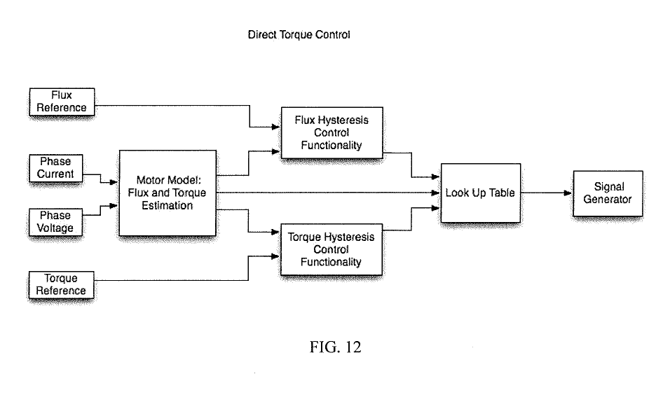

FIG. 12 illustrates a functional block diagram of a method for direct torque control. This method monitors Voltage and Current in the motor and calculates motor flux and torque. The stator flux linkage is determined by integrating Stator Voltage. The cross product of the measured motor current vector and stator flux linkage vectors create the torque estimate for the motor. A look up table or algorithm then determines the correct switching frequency.

Power Quality and Electromagnetic Interference Filtering

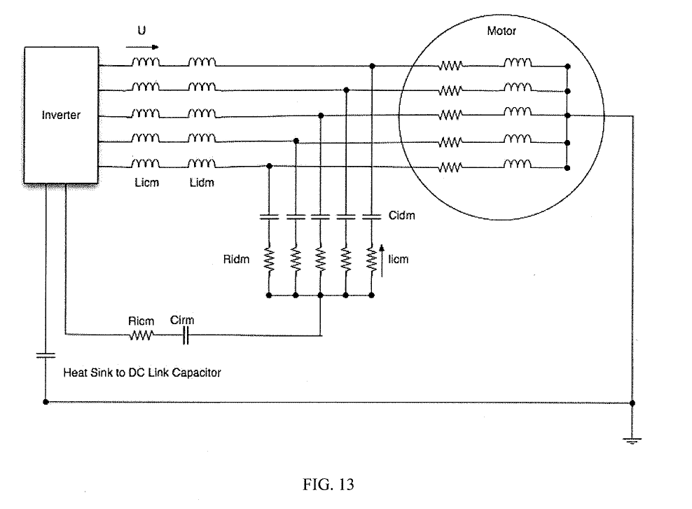

FIG. 13 illustrates Sinusoidal EMC Filtering

Conductive Coupling (Common-Mode and Differential-Mode) filtering can be accomplished by using capacitors and linking them to the heat sinks though a common ground and the power leads.

Inductive Coupling (Capacitive and Magnetic) filtering is used by coiling wires, and/or running them in parallel on the same axis to counter act noise from the main leads.

Radiative Coupling filtering is managed through appropriate shielding of source components, protecting both the on-board and off-board devices.

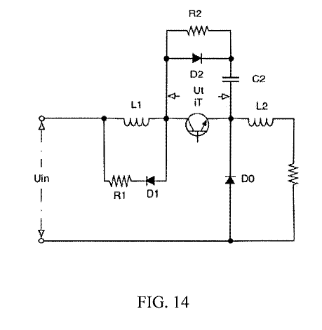

FIG. 14 illustrates a “turn-on” snubber and a “turn-off' snubber. For certain power applications and switching frequencies a Turn-On Snubber is used. Inductor “L1”, Resistor “R1”, and Diode “D1” decrease current stresses di/dt across MOSFET/IGBT. On the upper portion, a Turn-Off Snubber is used to decrease the voltage across the transistor. This is done with Resistor “R2”, Diode D2”, and Capacitor “C2”.

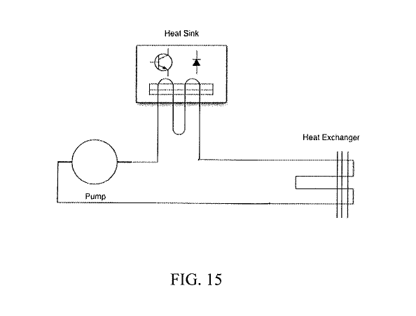

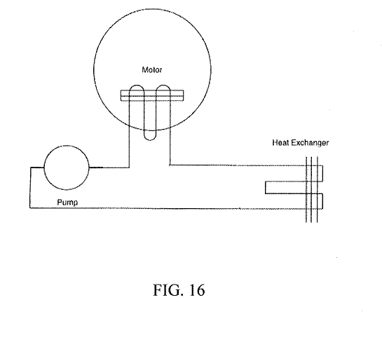

Thermal Management for the Power Electronics and Motor can either be done through air, water, or oil cooling depending on the power rating and environmental conditions. For example, FIG. 15 illustrates the fluid cooling of power electronics, and FIG. 16 illustrates the fluid cooling of the motor.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Other embodiments may be within the scope of the following claims.

What is claimed:

1. A motor comprising:
a stator having a first phase, a second phase, a third phase, a fourth phase, and a fifth phase, each phase producing a north or a south pole;
a rotor configured to rotate in accordance with one of the phases of the stator; and
a five-phase inverter configured to control the stator and rotor, the five-phase inverter having a plurality of upper and lower leg pairs, each leg pair configured to manage reverse power flow.
